(19) United States
(12) Patent Application Publication
(10) Pub. No.: US 2010/0046730 A1
(43) Pub. Date: Feb. 25, 2010

(54) SUBSCRIBER BARRING OF TELEMARKETING

(76) Inventor: Helge Rune Salvesen, Bjorbekk (NO)

Correspondence Address: ERICSSON INC., 6300 LEGACY DRIVE, M/S EVR 1-C-11, PLANO, TX, 75024, US

(21) Appl. No.: 12/441,497

(22) PCT Filed: Sep. 15, 2006
(86) PCT No.: PCT/NO2006/000318

§ 371 Date: Mar. 16, 2009

(51) Int. Cl. H04M 3/42

(52) U.S. Cl. 379/210.02

(57) ABSTRACT

A system is disclosed for barring unwanted calls comprising at least a calling party, a protocol, a receiving party where the calling party is connected to an originating node, and the receiving party is connected to a terminating node. The system further comprises means adapted to provide the calling party with at least one category/identifier, means adapted to give the receiving party a possibility to access a service/application on the terminating node where the receiving party can indicate at least one user defined category, and a protocol having spare bits suitable for transportation of the calling party's at least one category/identifier. It is further disclosed a corresponding method for barring unwanted calls.

### TECHNICAL FIELD

The present invention relates to the field of communication services in general, and in particular a system and method for subscriber barring of unwanted calls from telemarketing companies.

### BACKGROUND

Telephone subscribers are often bothered by unwanted telephone calls. Typically these calls originate from marketing companies, from humanitarian organisations, from sports clubs, from book clubs, from opinion poll companies etc. Quite commonly these are calls that are generated by an application where the goal is to reach as many subscribers as possible using as little time as possible.

In the following we will use the term telemarketing calls for calls of the above mentioned types. In fact in a number of countries a major part of the telephone numbers that are traced by the telephone users belongs to telemarketing companies, hence this indicates the large numbers of calls initiated by such companies.

To avoid telemarketing calls the most common solution today is for a subscriber (100, FIG. 1) to register with personal data and not telephone number in a central barring register (101), e.g. via the Internet. Hence it is an indirect method where the subscriber or the household of a subscriber does not directly communicate their preferences to their telephone operator regarding barring of unwanted calls. Instead they have to use a connecting link such as a central barring register (101, FIG. 1) to register that they do not want to receive telemarketing calls. It is up to the telemarketing companies (102) to use this register list to avoid making unwanted telemarketing calls to subscribers who do not want to receive such calls.

As indicated the existing solutions are based on central network registers (FIG. 1). Telemarketing companies may sometimes ignore these registers or the registers are not updated. Furthermore, in a home the individual residents can be called unless all the persons in the household are registered in the barring register. Evidently there are a number of practical problems connected with today's solutions for barring of unwanted calls, such as telemarketing calls;

the first is that the barring is associated with personal data such as personal I.D. code or social security numbers, thus all of the users associated with a phone number must register so as to stop unwanted calls,

the second problem is the problem of updating central registers and to impose respect for the registers at the telemarketing companies, this second problem is inherent of using an indirect system of barring, and

a third problem is that it is cumbersome to register in a central register, and further it is inconvenient to unregister, hence the common solution is not flexible.

Technically, telemarketing calls originate from some telemarketing company 201 (A-subscriber, FIG. 2) as described above, and quite often they are initialised by software applications. The call is routed through an originating node 200 over a backbone network (202) to a terminating node 210 where it is finally forwarded to a B-subscriber 211.

As is evident from above there is a need for a more reliable solution where subscribers are able to stop unwanted calls such as telemarketing calls in a more efficient way.

### SUMMARY

It is an object of the present invention to provide an improved solution for barring unwanted calls that avoids the problems discussed above.

In particular, it is an object to provide the called part with means for reliable and easy control of barring of unwanted calls.

These and other objectives are met by the invention disclosed in the accompanying independent claim 1 where in particular it is disclosed a system for barring unwanted calls comprising at least a calling party and a receiving party, where the calling party is connected to an originating node and the receiving party is connected to a terminating node. In said system, the originating node is adapted to signal at least one first category/identifier describing the calling party's area of activity to the terminating node. The terminating node is adapted to receive at least one user defined second category/identifier from the receiving party and store said second category/identifier. The terminating node is further adapted to compare the first category/identifier with the second category/identifier. If the first category/identifier is identical with the second category/identifier any call from the calling party to the receiving party is barred.

It is further disclosed a method for barring unwanted calls at a terminating node connected to a called party as disclosed in claim 12. Said method includes receiving a call setup message, said call setup message including at least one first category/identifier describing a calling part's area of activity. Said at least one first category/identifier is compared with at least one user defined second category/identifier. If the first category/identifier is identical with the second category/identifier the call is barred, else the call is set up to the called party.

The system described above is further characterized by a number of elements. One element is a terminating node adapted for bidirectional communication with a receiving party, as claimed in claim 5. The terminating node includes means for storing at least one user defined second category/identifier received from said receiving party. The terminating node is adapted to compare said second category/identifier with a first category/identifier received from a calling party, and if said first and second categories/identifiers are equal, to bar a call from said calling party.

Another element that is characteristic for the system is an originating node in a communication network, as claimed in claim 7. Said originating node is adapted for bidirectional communication with a calling party and includes means for registering the calling party with at least one first category/identifier associated with the calling party, said first category/identifier describing the calling party's area of activity.

Finally there is provided a protocol for setting up calls between a calling party and a called party in a communication network. The protocol is adapted for transporting a number of bits associated with at least one first subscriber category/identifier between an originating node connected to the calling party and a terminating node connected to the called party.

An advantage of the Invention is the feature of blocking telemarketing calls from marketing companies, from humanitarian organisations, from sports clubs, from book clubs, from opinion poll companies etc. in a reliable new way that cannot be circumvented. Further it is also advantageous that a B-subscriber keeps the control of wanted and unwanted calls by pressing a simple key-code to activate barring of telemarketing calls in his local node (terminating node), and hence can stop unwanted calls immediately.

### BRIEF DESCRIPTION OF THE DRAWINGS

In order to make the invention easier to understand, the following discussion will refer to the accompanying drawings.

FIG. 1 is a schematic diagram illustrating a prior art method of barring.

FIG. 2 is a schematic diagram showing the communication setup between the calling and called parties in a telephone network.

FIG. 3 is a list of possible codes showing calling party category content.

FIG. 4 shows a list of codes that may be used in an Initial Address Message.

FIG. 5 is a flow diagram illustrating analysis of a incoming calls in a terminating node.

FIG. 6 is a schematic diagram illustrating a first embodiment of the invention.

FIG. 7 is a schematic diagram illustrating a second embodiment of the invention.

FIG. 8 is a schematic diagram illustrating a third embodiment of the invention.

FIG. 9 is a schematic diagram illustrating a fourth embodiment of the invention.

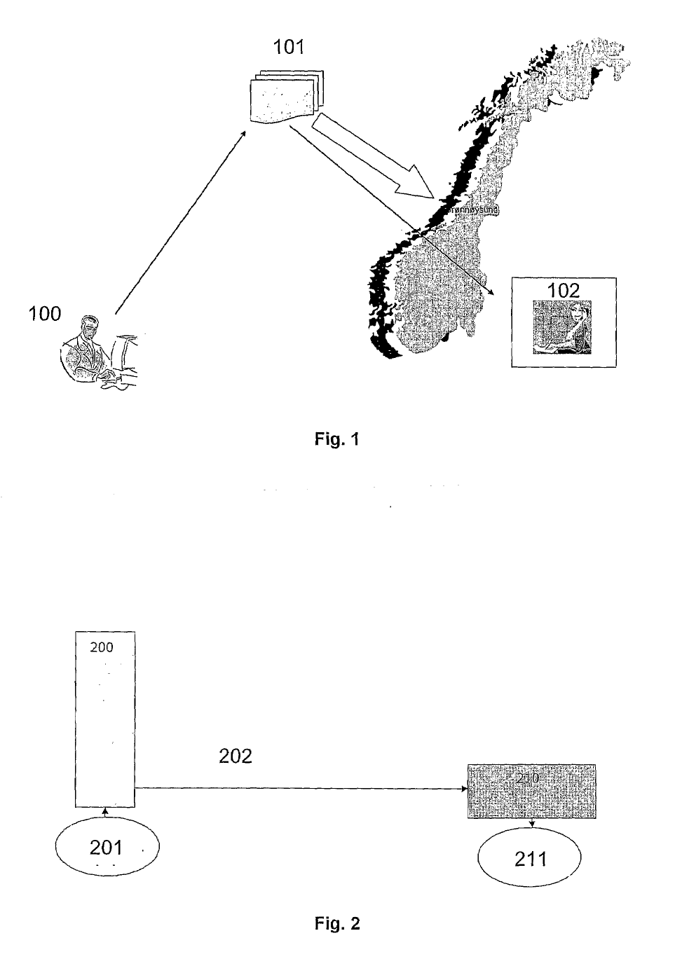

### DETAILED DESCRIPTION

In the following the present invention is described with reference to the accompanying drawings, the drawings are included herein so as to ease the readability and understanding of the invention and not to restrict the scope of protection. A person skilled in the art will realize other applications and modifications within the scope of the invention as defined by the appended claims.

One idea disclosed by the present invention is to circumvent the principle of associating personal I.D. code or personal data with telephone numbers. Another idea is to depart from the common solution of only using a central barring register as a connecting link between a telemarketing company and a B-subscriber. According to the present invention there is disclosed a user oriented system for barring unwanted calls where there is no need for a connecting link such as a central register, or where the central register is working independent of the present solution.

The latter idea discussed above can be achieved having in addition to a central register functionality in a terminating node (FIG. 2) 210 such as your local exchange which stops unwanted calls. This function is controlled by the B-subscriber 211 and can be configured to reject calls from telemarketers 201 and other calling parties 201. The telephone operators must give the telemarketing companies 201 a subscriber category or an identifier (for ease of understanding denoted TMC) that will be transferred through a network and analysed in the terminating node 210 or terminating exchange 210. The subscriber category identifier (TMC) will indicate whether a subscriber is a telemarketing company or not.

The barring solution according to the present invention compares the telemarketing category/identifier with the categories in a user activated marketing barring filter (service/application). The user 211 can be a person 211, a group of persons 211 a subscriber 211 etc. The user 211 is entitled to tailor a barring filter in his local node 210 or local exchange 210. If a A-subscriber 201 wants to call an A-subscriber 211 and there is a match between the B-subscriber initiated category/identifier (barring category) in the barring filter in the terminating node 210 and the category/identifier associated with the A-subscriber 201 the call will be rejected. Otherwise, the call will be setup between the calling party 201 such as a Telemarketing A-subscriber and a receiving party 211, i.e. the B-subscriber. Normal calls from all other A-subscribers will not be affected.

In the following discussion it is illustrated a non limiting example of how a B-subscriber 211 can implement/initiate barring of unwanted calls in his local node 210 (terminating node). It is familiar for most end users (subscribers) to input codes on a telephone set so as to activate services from an operator, such as forwarding services, answering machines, wake up calls, telephone conferences etc. The features of barring unwanted calls can be activated in the same manner as the mentioned familiar services. To illustrate one possible method of initiating barring of unwanted calls an exemplification is disclosed below:

The B-subscriber 211 keeps the control by pressing a simple key code on his phone, and can stop unwanted calls immediately by activation of *xy*, and deactivate by typing #xy#, where xy is chosen as an idle service number within the range 00 to 99. If a subscriber has different barring alternatives optional classes can be chosen, ant the activation code may be like *xy*z#, where z is a number to choose between different barring alternatives.

The example above is just an example of how the user interface can be operated. Other more modern “Web” methods can also be utilized when for example the user interface is on a mobile phone.

The system for barring unwanted calls according to the present invention can be divided into elements where each element has its own specific feature being characteristic for the invention. The system comprises elements at the originating end 200, 201 and at the terminating end 210, 211. Furthermore as indicated above there is a need for a transport/signalling protocol having spare bits that can carry additional information such as A-subscriber category/identifier from an originating node 200 to a terminating node 210 over a network. At the originating end 200, 201 there is at least one A-subscriber such as a telemarketing company 201 which is connected to an originating node 200. The A-subscriber will be registered at his operator and will be given at least one telemarketing subscriber category/identifier. The at least one category/identifier is in this example for readability purposes named TMC (Telemarketing Category). At the terminating end 210, 211 the B-subscriber 211 (receiving party 211), such as an individual person with his own telephone is connected to a terminating exchange 210 or terminating node 210. The B-subscriber 211 is given the possibility to access a service on the terminating exchange/terminating node 210 as a user-controlled subscriber category by e.g. pressing a simple key code as described above. This category is for explanatory reasons in this example named TBC (Telemarketing Barring Category).

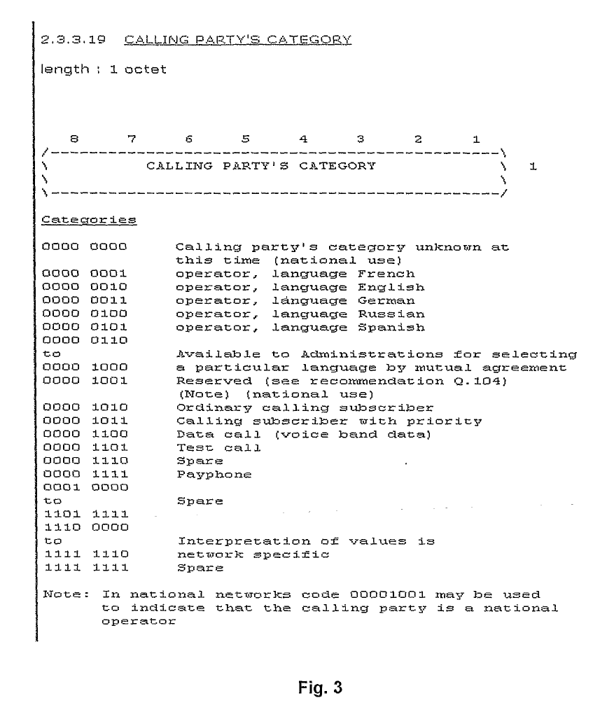

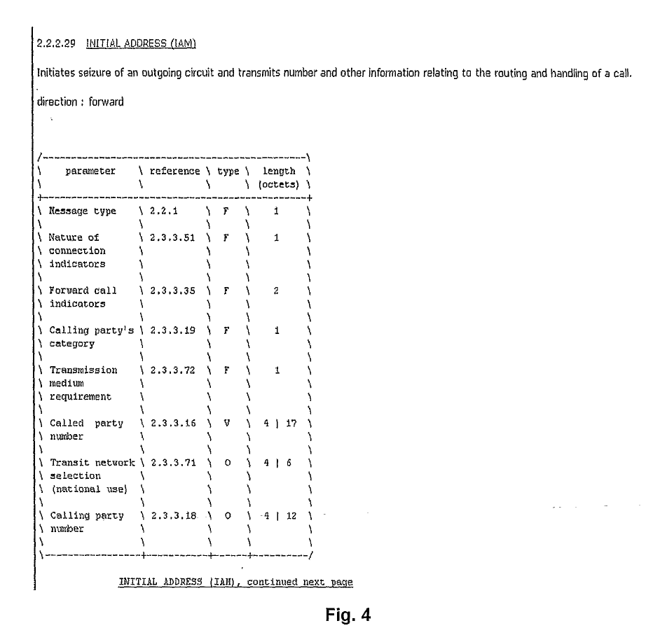

The transport/signalling protocol indicated above is network dependent and many protocols are suitable for transfer of category/identifier (i.e. TMC). However, for ease of understanding in the following discussion an example of such a protocol is ISUP (ISDN User Part protocol). Using ISUP, the TMC category can be transported to a local users exchange 210 (terminating node 210), for checking against a barring filter. The TMC category is mapped into one idle calling party's 201 category (FIG. 3) (Calling Party's Category, CPC) in initial address message (IAM) (FIG. 4) at the originating node 200 at start of a call. Other signalling systems have similar messaging systems and similar mapping can take place at the originating node 200 as with ISUP and CPC, hence ISUP and CPC is disclosed for readability and is only an example. CPC (FIG. 3) has 255 different values, but not all are used, in fact the range 0001 0000_{b}-1101 1111_{b} (16-223) are spare bits. CPC is transferred from originating 200 to terminating node 210. CPC is also called ACAT

In FIG. 4 a part of the Initial Address message where CPC is defined is shown.

In the discussion above only one class of category/identifier is described. However, more classes are possible, both of TMC and TBC, if other types of call centre/telemarketing companies are defined, such as sport clubs, humanitarian organisations and opinion poll companies etc. Adding more classes renders a number of filtering possibilities. More classes necessitates transfer of more bits from the originating node 200 to the terminating node 210, this can be accomplished using more spare bits in a transporting/signalling protocol or it can be accomplished by manipulating protocols so that they will render more spare bits. A B-subscriber 211 may as an example want to let calls from humanitarian organisations through whereas he wants to stop all other types of calls that in the present application is defined as telemarketing calls.

The backbone network (202) between an originating node 200 and a terminating node 210 can be circuit switched (ISUP, TUP CAS, etc) or packet switched (IP, ATM etc.) for wireless communication between a calling party 201 and a receiving party 211 or any combination of wireless and wired communication between said parties.

The basic principle, carrying A-subscriber 210 information related to type of subscriber from an originating node 200 over a backbone network to a terminating node 210 are in itself completely network independent. Furthermore crosschecking the information related to type of subscriber at the terminating node 210 against a predefined user initiated table/filter is merely a matter of developing software applications; hence this aspect of the invention is also network independent.

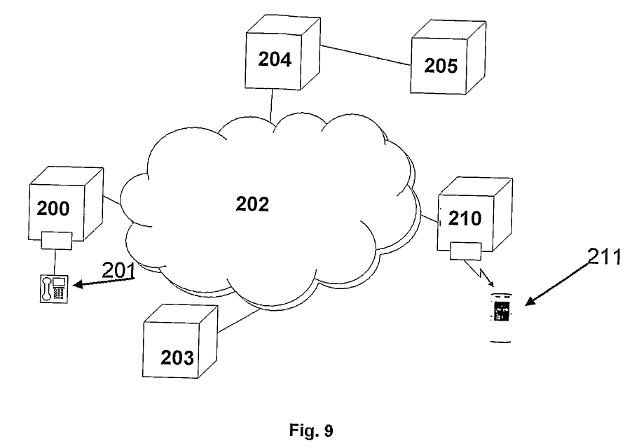

In the following, examples of implementations of the present invention is disclosed with reference to the accompanied FIGS. 6-9

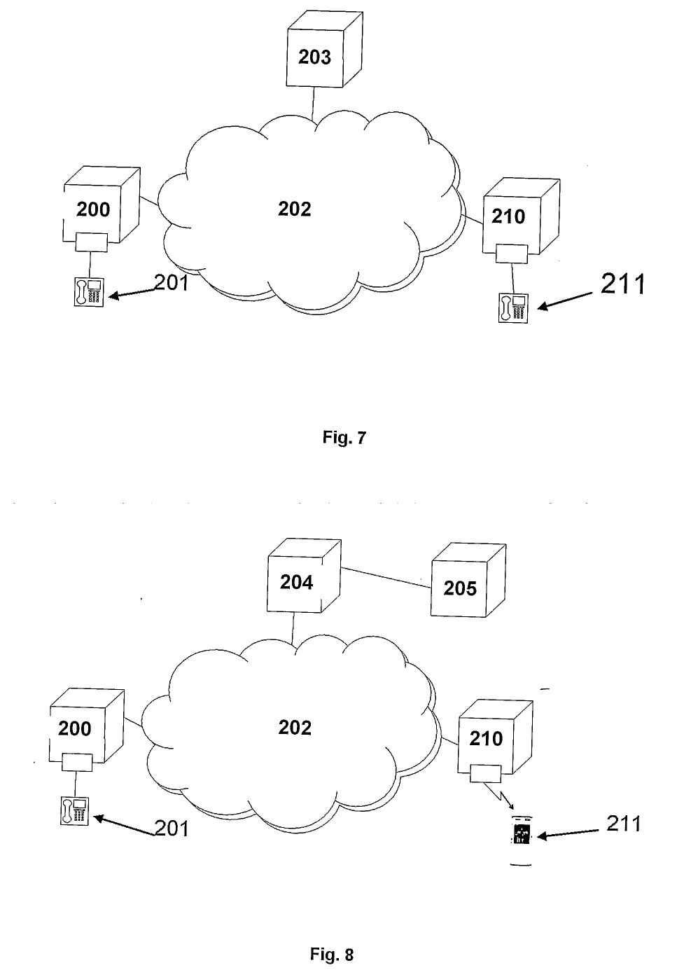

In FIG. 6 and 7 it is shown examples of wired communication between an A-subscriber 201 and a B-subscriber 211. FIG. 6 shows a system where A-subscriber 201 calls a B-subscriber 211 and where the networks are circuit switched and the B-subscriber 211 uses a fixed telephone. In this example the subscriber categories (i.e. TBC) are stored and analyzed in the terminating node 210. FIG. 7 also discloses a system for wired communication where the B-subscriber 211 uses a fixed telephone. However, in this example the backbone network is packet switched (i.e. IP, ATM etc). The subscriber categories initiated by the B-subscribers 211 is in this example stored in a telephony server 203.

For wireless subscribers (FIG. 8, 9), the subscriber categories are stored either at a Local Exchange 200, a Telephony Server 203 or a Mobile services Switching Centre (MSC) 204 depending on the system architecture. Further, this kind of information can be stored in a Home Location Register (HLR) 205 and hence when a subscriber is roaming then the local node (exchange, MSC, etc.) will connect to a Visitor Location Register (VLR, not shown), where the VLR is storing a copy of the subscriber categories or where the VLR or the local MSC retrieves category data associated with a subscriber at the subscribers HLR. Whether a call is barred by HLR or VLR is not important. It is a matter of choice if the analysis/barring are carried out in the HLR implying that the call will never be set up and it will never reach VLR, or if the analysis/barring are carried out in the VLR as indicated above.

The use of HLR and MSC is commonly known entities within the Global System for Mobile Communication (GSM) network. However, the same possibilities and the same principles can be applied to other networks such as 2.5 G (General Packet Radio Service, GPRS) 3G (e.g. Universal Mobile Telecommunications System, UMTS) networks or other known networks. The terminologies may however be different.

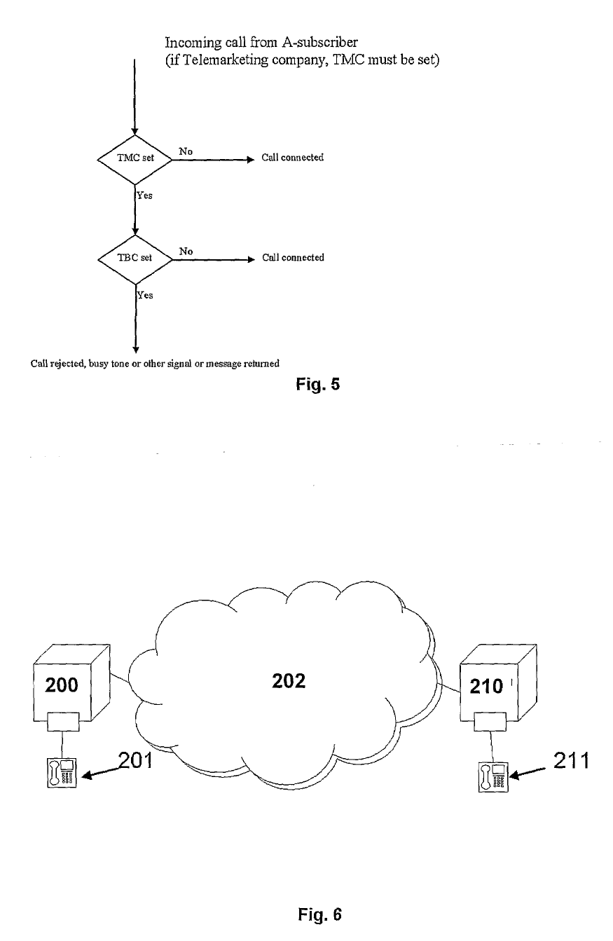

In the previous sections focus has been directed towards transportation of categories/identifiers (TMC) and mapping of these against corresponding categories/identifiers (TBC) at a receiving node in more general terms. In the following it is described an example of a call setup exemplified by a table and description of logical values (FIG. 5) denoted to TMC and TBC. FIG. 5 illustrates analysis of A-numbers on terminating side.

When a call is being made from a telemarketer or the like, the TMC category is mapped into CPC. This situation is noted as TMC Set (TMC-1) (FIG. 5). Otherwise, if the call is originating from a non-telemarketer (family, friends colleagues etc., TMC is Not Set (TMC-0).

Similar, if a B-subscriber 211 has indicated that he wants to bar unwanted calls TBC will be set (TBC-1) (FIG. 5) and if not TBC is Not Set (TBC-0).

| TMC | TBC | Call | Comments |
|---|---|---|---|
| 0 | 0 | 1 | TMC = “0”, non telemarketing A-subscriber; |
| | | | TBC = “0”, B-subscriber is not barring |
| | | | telemarketing calls |
| 0 | 1 | 1 | TMC = “0”, non telemarketing A-subscriber |
| | | | TBC = “1” B-subscriber is barring telemarketing |
| | | | calls |
| 1 | 0 | 1 | TMC = “1”, telemarketing A-subscriber; |
| | | | TBC = “0”, B-subscriber is not barring |
| | | | telemarketing calls |
| 1 | 1 | 0 | TMC = “1”, telemarketing A-subscriber; |
| | | | TBC = “1”, B-subscriber is barring telemarketing |
| | | | calls; Call = “0”, rejected calls |

In the description above the invention has been disclosed by way of example however many other embodiments will be obvious to a person skilled in the art, such as the use of multiple classes, the use of different backbone networks or the use of different types of handsets at the calling 201 and/or receiving party 211.

1.-16. (canceled)

17. A system for barring unwanted calls among at least a calling party and a receiving party where the calling party is connected to an originating node and the receiving party is connected to a terminating node, comprising:
an originating node;
a terminating node;
wherein the originating node is adapted to signal at least one first category/identifier describing the calling party's area of activity to the terminating node;
wherein the terminating node is adapted to receive at least one user defined second category/identifier from the receiving party and store said second category/identifier, the terminating node further being adapted to compare the first category/identifier with the second category/identifier, and if the first category/identifier is identical with the second category/identifier the terminating node adapted to bar any call from the calling party to the receiving party.

18. The system as claimed in claim 17, wherein the terminating node is adapted to receive and store a plurality of user defined second categories.

19. The system as claimed in claim 17, wherein the originating node and the terminating node are communicating on a packet switched network, said network including a telephony server adapted to receive said at least one first category/identifier from the calling party and store the said at least one first category/identifier.

20. The system as claimed in claim 17, wherein the terminating node or the originating node are communicating on a wireless network, said wireless network including a Home Location Register or a Visiting Location Register wherein said at least one user defined second category/identifier is stored.

21. A terminating node in a communication network, the terminating node being adapted for bidirectional communication with a receiving party, comprising:
means for storing at least one user defined second category/identifier received from a receiving party; and
service/application means for comparing said second category/identifier with a first category/identifier received from a calling party, so that if said first and second categories/identifiers are equal said means adapted to bar a call from said calling party.

22. The terminating node as claimed in claim 21, wherein the service/application means is a filter adapted to compare a number of first category/identifiers with at least one second category/identifier stored in the terminating node by the receiving party.

23. An originating node in a communication network, said originating node being adapted for bidirectional communication with a calling party; comprising means for registering the calling party with at least one first category/identifier associated with a calling party, said first category/identifier describing the calling party's area of activity.

24. A protocol embodied on a computer readable medium adapted to be loaded into and executed by a processor, said protocol for setting up calls between a calling party and a called party in a communication network, comprising means for transporting a number of bits associated with at least one first subscriber category/identifier between an originating node connected to the calling party and a terminating node connected to the called party.

25. The protocol of claim 24, wherein the at least one category/identifier is adapted to be mapped into at least one idle byte in the protocol.

26. The protocol of claim 24, wherein the protocol is an ISDN User Part protocol.

27. The protocol of claim 26, wherein the at least one first category/identifier is mapped into at least one idle field in an Initial Address Message.

28. A method for barring unwanted calls at a terminating node connected to a called party, said method comprising the steps of:
receiving a call setup message, wherein said call setup message includes at least one first category/identifier describing a calling part's area of activity;
comparing said at least one first category/identifier with at least one user defined second category/identifier, and
if the first category/identifier is identical with the second category/identifier, barring the call, else setting up the call to the called party.

29. The method of claim 28, further comprising the step of providing the terminating node with said second category/identifier(s) where the second category/identifier(s) is provided by the called party.

30. The method of claim 28, further comprising the step of providing the terminating node with said second category/identifier(s) that are mapped to second subscriber numbers and where the second category/identifier(s) are provided by second subscribers.

31. The method of claim 28, wherein the method further comprises the step of mapping, at an originating node, the at least one first identifier/category into a protocol.

32. The method of claim 31, further comprising the step of mapping the first identifier/category into a message and transferring the message to the terminating node.
